(19) United States
(12) Patent Application Publication
(10) Pub. No.: US 2015/0068494 A1
(43) Pub. Date: Mar. 12, 2015

(54) METHOD OF CONTROLLING AN INJECTION TIME OF A FUEL INJECTOR

(71) Applicant: DELPHI AUTOMATIVE SYSTEMS LUXEMBOURG SA, BASCHARAGE, LU (LU)

(72) Inventor: Didier Robart, Crauthem (LU)

(73) Assignee: DELPHI AUTOMOTIVE SYSTEMS LUXEMBOURG SA, BASCHARAGE (LU)

(21) Appl. No.: 14/391,596

(22) PCT Filed: Apr. 5, 2013
(86) PCT No.: PCT/EP2013/057215

§ 371 Date: Oct. 9, 2014

(30) Foreign Application Priority Data
Apr. 12, 2012 (EP) 12163948.8

(51) Int. Cl. F02D 41/36; F02D 41/24

(52) U.S. Cl. CPC F02D 41/365; F02D 41/2467
USPC 123/445

(57) ABSTRACT

A method of controlling fuel injection in an internal combustion engine is presented. A drive signal is generated for each injection event, with which the injector is kept open to spray fuel in accordance with a requested fuel quantity. The drive signal has a duration based on a pulse width that is determined from an injector-specific correspondence function defining the pulse width vs. a corresponding open time variable representative of injector open time. The open time variable is determined on the basis of a master performance function defining the requested fuel quantity in function of the open time variable.

### FIELD OF THE INVENTION

The present invention generally relates to internal combustion engines and more generally to injection control in such engines.

### BACKGROUND OF THE INVENTION

The contemporary design of internal combustion engines must cope with the increasingly stringent regulations on pollutant emissions. Accordingly, automotive engineers strive for designing engines with low fuel consumption and low emission of pollutants, which implies including electronic devices capable of monitoring the combustion performance and emissions in the exhaust gases.

In this connection, a proper operation of a fuel-injected engine requires that the fuel injectors and their controller allow for a timely, precise and reliable fuel injection. Indeed, it is well known that problems arise when the performance, or more particularly the timing, and the quantity of fuel delivered by the injectors diverge beyond acceptable limits. For example, injector performance deviation or variability will cause different torques to be generated between cylinders due to unequal fuel amounts being injected, or from the relative timing of such fuel injection. And this problem is particularly acute when injecting small fuel quantities, due to response delays at opening and closing.

In order to take into account the specificities of a fuel injector, it has been proposed to associate to a given fuel injector a number of performance parameters thereof. These performance parameters are, e.g., encoded in a bar code applied to the injector, so that the performance parameters can be retrieved by a bar code scanner at the time of installation in the engine and transferred to the engine control unit (ECU). Such method for fuel injector parameters installation is for example described in U.S. Pat. No. 7,136,743.

Another method of fuel injector installation has been disclosed in WO2011/073147, which uses a segmented master performance curve. Each fuel injector to be installed in the engine is provided with specific fuel injector parameters in a machine-readable format, and these parameters are transferred to the engine ECU. Fitting information, preferably coefficients for a characteristic equation attributed to each respective segment of the master flow curve, are contained in these fuel injector specific parameters.

### OBJECT OF THE INVENTION

The object of the present invention is to provide another approach for injection control in an internal combustion engine that takes into account individual flow specificities of fuel injectors.

This object is achieved by a method as claimed in claim 1.

### SUMMARY OF THE INVENTION

The present invention relates to a method of controlling fuel injection in an engine, wherein for each injection event a drive signal is generated and applied to the injector in order to open it and spray fuel during a certain time, in accordance with a requested fuel quantity.

In accordance with the present invention, the length of the drive pulse, i.e. the time period during which the drive signal is applied to the injector, is based on a pulse width (PW) that is determined from an injector-specific correspondence function defining the pulse width (PW) vs. a corresponding open time variable (A) representative of injector open time.

This open time variable (A) is first determined on the basis of a master performance function defining the requested fuel quantity in function of the open time variable.

The present method relies on the observation made by the present inventor that, although part-to-part injector variations exist for a given injection design, mainly reflected through different pulse widths per injectors for a given delivered fuel amount, the time interval during which the injector valve is actually open is fairly constant. In other words, although fuel injectors may have opening and closing delays that vary from part-to-part, the global behavior is that, in order to deliver a given fuel quantity, the time period during which the injector is open (i.e. the pintle/needle is off its seat) is relatively constant.

The “open time” then preferably represents the time period between the moment the injector pintle/needle leaves its fully closed position to open and the moment it returns to its fully closed position, to close approximation.

The open time of the injector may generally be expressed by the following formula:

PW+a·CR−b·OD (eq. 1)

where:

PW is the pulse width, i.e. the logic command applied to the fuel injector to command the opening;

CR is the measured Closing Response, i.e. the time elapsed from the end of the pulse width signal to the actual closing of the injector valve;

OD is the Opening Delay, i.e. the time elapsed between the beginning of the pulse width signal and the moment the injector pintle starts moving;

and a and b are coefficients allowing compensation for various effects, as may be required.

In this connection, one may notice that for some injector designs the opening delay may be substantially constant (for all injectors of such design), so that, in close approximation, the open time may simply be calculated as PW+a·CR, where frequently a=1.

Each injector-specific correspondence function may be stored in a memory as a table/map with discrete values of open time variable A vs. pulse width PW. The injector-specific correspondence functions may also be expressed as mathematical expression, e.g. by one or more characteristic equations. It is even possible to combine mapped values and mathematical expression to describe the A-PW relationship on respective pulse width ranges.

In the context of the present invention, the master performance function defines the relationship between the injected fuel quantity (or fuel request) and the corresponding open time variable (A), which is representative of the time period during which the injector is open, as explained above. Experiments carried out for various fuel injector designs have shown that for a given technology or design of fuel injector, the dispersion of the flow vs. injector open time is much less significant than for the conventional flow curves: flow vs. pulse width (i.e. flow vs. the logic signal).

The master performance function (flow/quantity vs. opening time) used in the present invention is built experimentally from test data to be representative of a population of injectors according to one design. This testing is preferably carried out in such a way that the master performance function is statistically representative for a population of fuel injectors of same design.

The term “injector design” herein refers to the technological choices for the construction of the fuel injector, including choice in terms of dimensions, mechanical and electro-mechanical components, but excluding manufacturing tolerances of the injector and of each injector component.

It shall be appreciated that, as compared to the conventional approach implementing injector flow corrections at constant pulse width, the present invention takes a different approach since the input for the injector command is the fuel flow dependent “open time variable” (herein noted A). Accordingly, after an open time variable value (A) corresponding to a desired fuel amount (as requested by the ECU) is obtained on the basis of the master performance function, this value of open time variable (A) is used as an input to the injector-specific correspondence function containing injector specific values of the open time variable (A) versus corresponding pulse widths (PW). It is thus in the correspondence function that the injector specificity is reflected. In the different correspondence tables, a same open time variable value will often correspond to different pulse widths for different injectors.

The practical implementation of the injector-specific correspondence functions may vary depending on engine management procedures. Preferably, the correspondence function takes the form of a table or mapping (stored in a memory) with discrete values of open time variable vs. pulse width. In many instances, the determination of the pulse width will require mathematical analysis approaches, such as e.g. interpolation or extrapolation or other appropriate mathematical processing. However, with appropriate data processing one could use mathematical expressions (e.g. characteristic equations) describing the functions, although it appears too resource consuming for a simple implementation.

Such correspondence tables may be pre-filled with standard (or master) values for the sets of points (open time variable; pulse width). The pre-filling operation can occur through programming of the ECU; or sets of values can be associated with the fuel injectors and transferred into the ECU at injector installation. Alternatively, the correspondence tables may be initially empty, filled in by learning at engine start-up, and then only used once they have been sufficiently populated. While the values for the correspondence tables are still being learned, injection can be performed on the basis of a conventional (master) flow curve: fuel vs. pulse width.

In all cases, the correspondence table/function is preferably updated as often as required, generally by learning the OD and CR for pulse widths that have actually been applied to the fuel injectors.

A variety of methods are available for detecting the opening time and the closing time of fuel injectors based on voltage or current detection of fuel injectors using solenoid actuators or piezo-actuators. For solenoid-actuated injectors however, the detection of opening time and closing time is preferably based on injector solenoid voltage.

Another benefit of the invention is that the injector-specific correspondence functions are generally bijective, which simplifies the implementation of the method in the controller.

In a preferred embodiment, the injector-specific correspondence function uses a pre-determined or learned pivot point defined by a given open time variable and a given pulse width, which corresponds to zero flow (or nearly zero flow). Such pivot point is advantageous at low fuel amounts, respectively low values of open time variable, since it can be used as lowest point for the determination of the pulse width.

These and other preferred embodiments are recited in the appended dependent claims 2 to 11.

It remains to be noticed that the present invention is applicable to both gasoline and diesel engines and to solenoid and piezoelectric injectors. Furthermore, although the invention has been developed for injector operation in the ballistic domain, it would also apply beyond ballistic.

According to another aspect, the present invention relates to a fuel injection system as claimed in claim 12.

### BRIEF DESCRIPTION OF THE DRAWINGS

The present invention will now be described, by way of example, with reference to the accompanying drawings, in which:

FIG. 1: is a graph showing the flow curves of an exemplary set of fuel injectors as well as a conventional master flow curve;

FIG. 2: is a principle curve illustrating the pintle lift vs. time;

FIG. 3: is a graph illustrating flow (mg of fuel per pulse) vs. opening time for a set of fuel injectors as well as the master performance curve;

FIG. 4: is a graph illustrating the plot of the correspondence table, i.e. where the opening time is plotted vs. pulse width for a number of fuel injectors, in the ballistic domain; and

FIG. 5: is a graph illustrating a plot of the correspondence tables including the pivot point.

### DETAILED DESCRIPTION OF PREFERRED EMBODIMENTS

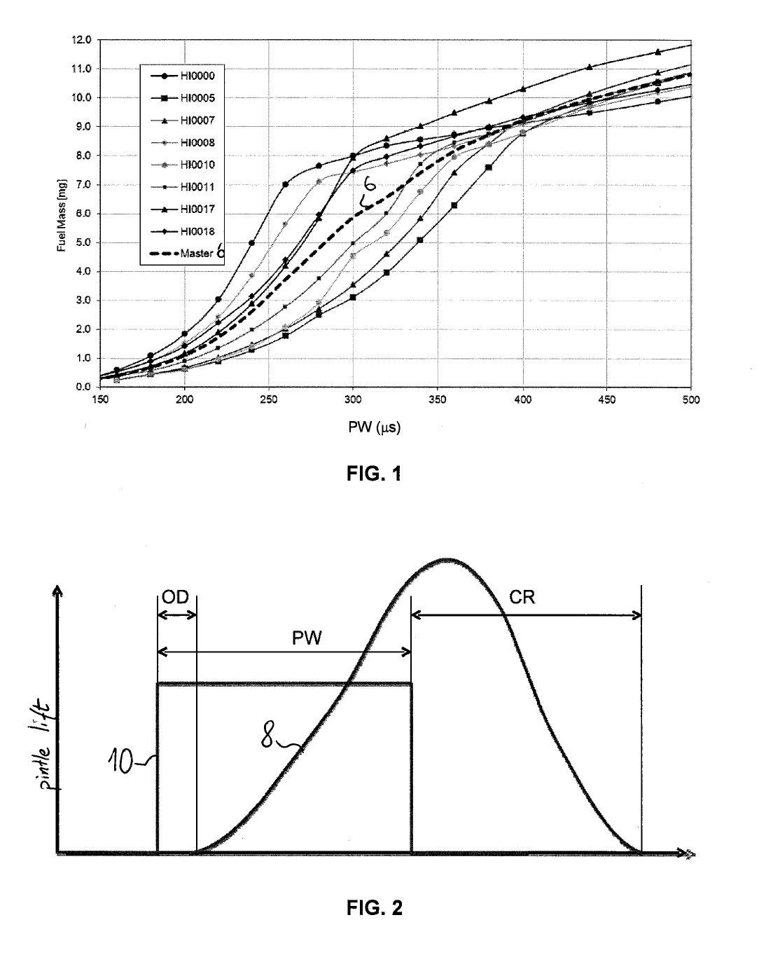

FIG. 1 illustrates a conventional master flow curve, i.e. a graph of fuel flow (fuel mass) vs. pulse width (time), representative of a fuel injector population, typically injectors produced in accordance with a same manufacturing technology (same construction). The master flow curve is preferably statistically representative of the injector population and has been obtained by detailed and systematic flow tests of injectors over the full range of pulse widths. In FIG. 1, the master flow curve is represented by the dashed line and indicated 6 and reflects the statistically representative flow behavior of a given design of solenoid-actuated fuel injector. The other curves represent measured flow curves of individual injectors, i.e. specific flows.

As can be seen, the shape of the master performance curve 6 is rather complex and can in general only be globally described by an equation comprising at least a third-order polynomial, and typically higher. Such flow behavior has become common nowadays, especially with advanced fuel injectors.

A number of conventional fuel injector control processes rely on a characteristic equation describing the master flow curve to determine the pulse width corresponding to a desired fuel amount.

As described e.g. in U.S. Pat. No. 7,136,743 a polynomial equation may be stored in the engine ECU for each fuel injector. On the engine assembly site, the fuel injector is assembled in the engine and a transfer device comprising a bar code reader is used to retrieve injector specific coefficients and to transfer them into the ECU. In the ECU, these coefficients are used as coefficients for the characteristic polynomial for injection control in the cylinder in which this specific injector is mounted.

Another method is described in WO2011/073147, which uses a segmented master flow curve, the flow behavior being described for each segment by a respective characteristic equation.

It may be noticed that the graph of FIG. 1 only shows the ballistic operating region of a fuel injector, where part-to-part variations are particularly significant. As it is known to those skilled in the art, the term ballistic is used to designate pintle movements for which the pintle essentially opens and closes, without remaining in (or even reaching) the fully open position. The problem of operating in the ballistic domain is that the pintle travel is particularly affected by opening and closing responses (or delays). A fuel injector generally comprises a valve group having a needle or pintle assembly that is axially moved in order to open and close one or more flow orifices through which fuel is sprayed in the engine. The fuel injector further includes an actuator, e.g. of the solenoid or piezoelectric type, that permits moving the pintle, against a return spring, to open the valve group and spray fuel in the engine combustion chamber.

FIG. 2 shows a pintle lift curve 8 describing a bell-shape, which is typical for the ballistic domain and illustrates the opening and closing responses. Reference sign 10 indicates the logic, drive signal that is applied to the fuel injector and causes opening thereof, by which fuel is sprayed in the engine combustion chamber.

The drive signal 10 is a pulse having a pulse width indicated PW, which is the time period during which the logic signal is applied. As can be seen, on application of the drive signal 10, it takes a certain time until the pintle starts moving; this time period is referred to as the “opening delay” or OD.

The time elapsed between the end of the drive signal 10, respectively the end of PW, and the moment the pintle reaches its valve seat and stably closes the injector valve, is referred to as closing response, herein noted CR.

A variety of methods are available for detecting the opening time and the closing time of fuel injectors, in particular based on injector solenoid voltage or current detection. WO 03/023211, e.g. describes a method of determining response times of electromagnetic devices. The determination of injector response times at switch-on and switch-off is based on current detection; the determination of the response time at closing is also described based on voltage detection. Alternatively, in the context of the present method the determination of the injector pintle closing response is preferably carried out based on the voltage feedback from the injector, i.e. from its solenoid actuator. The voltage may be measured across the injector coil terminals. When the injector armature hits the seat and stops, there is a visible and measurable inflection in the slope of the injector coil voltage. One may take the derivative of the coil voltage and the local maximum (the signal is generally a negative quantity) of the derivative of the coil voltage happens to correlate with the closing time.

As it will be understood, the injected fuel quantity is proportional to the area below curve 8. A suitable formula for indicating the amount of fuel (Q) delivered by the fuel injector in response to the drive signal 10 may be:

Q=c·(PW+a·CR−b·OD) (eq. 2)

Where coefficient a is provided to compensate for reduced flow rates when the pintle is in transit between the extremum positions (closed-fully open)—which is mostly the case in the ballistic domain. Coefficient b is adopted for potential corrections; it is however considered that in most case b=1 since there is no fuel flow before the pintle starts moving.

And the injector open time, i.e. the time during which the pintle is off its seat, may be expressed as in equation 1, as mentioned earlier:

A=PW+a·CR−OD (eq. 3)

This open time is noted A and hereinafter referred to as the open time variable. When the variability of the opening delay is very low, the term OD can even be omitted for comparison purposes, for some injector designs as explained earlier.

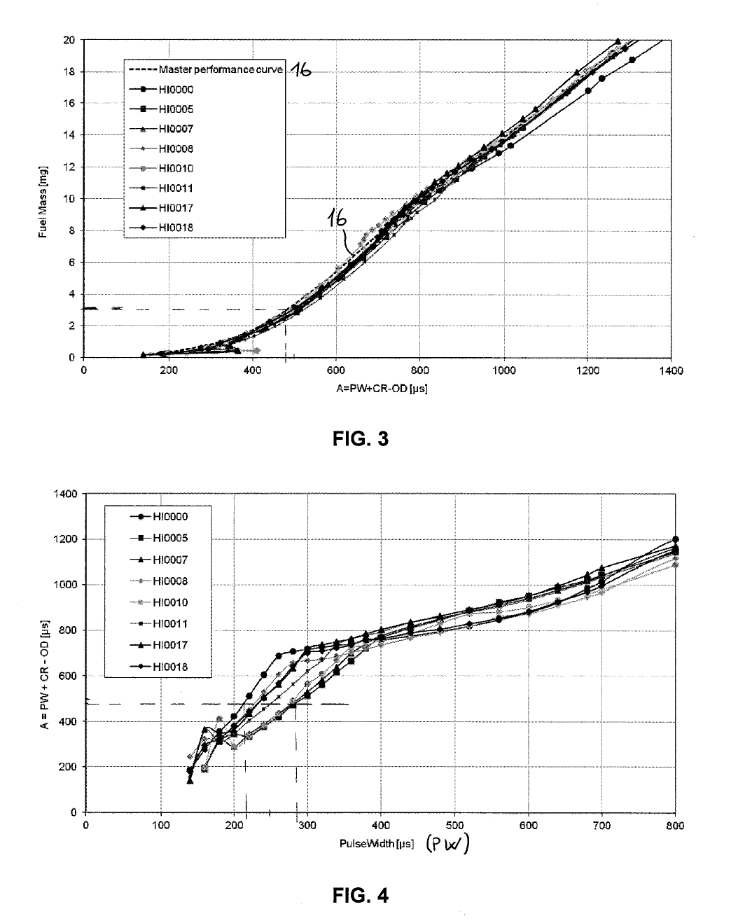

Turning now to FIG. 3, the fuel quantity Q is plotted vs. the open time variable A representative of the time period during which the injector valve group is open. A homogeneous behavior can be observed in this plot, which illustrates that injector open times to deliver a given fuel mass are fairly constant. The present method relies on this finding.

In other words, although a conventional flow vs. PW graph exhibits significant part-to-part variations, and non-negligible variations exist in terms of OD and CR, open times (A) are quite similar between injectors to deliver a same fuel amount.

The graph of FIG. 3 can be determined in the same conditions as the graph of FIG. 1. Indeed, for each of the pairs (Fuel mass; PW) of the curves shown in FIG. 1, it is also possible to determine the OD and CR related to the PW, and then to compute the corresponding open time variable A.

Furthermore, one can elaborate a master performance function (Flow vs. open time variable A) from representative test data, preferably in a way that is statistically representative for a given fuel injector design. In FIG. 3, the master performance function is plotted as curve 16.

The master performance curve 16 is thus advantageously a model function that can be expressed mathematically, by one or more equations, or actually any mathematical expression. The ECU is preferably configured to operate with such mathematical expression in order to avoid interpolation. However, the master performance function could alternatively be programmed/stored in the ECU as a table or map, i.e. with discrete values, although this is not preferred.

Now, once the A value representing the open time for the desired fuel amount has been determined from the master performance function 16, the pulse width PW for the drive signal is determined from an injector-specific correspondence function expressing the open time variable A vs. the pulse width PW. One such correspondence function exists for each fuel injector in the engine, so as to take into account injector specificities. In the present variant, the injector-specific correspondence functions take the form of tables (or maps—stored in a memory) with discrete values of open time variable A vs. PW.

FIG. 4 graphically illustrates the content of such correspondence tables for 8 fuel injectors of same design (same ones as in FIG. 3). Each injector-specific correspondence function is defined by pairs (A; PW); and the variability between each injector can be observed.

Suppose that the ECU has determined that a fuel mass of 3 mg has to be injected. It is derived from the master performance function of FIG. 3 that this requires an opening time A of 480 μs. As explained above, although injector closing and response delays may vary, altogether an injector will remain open during about 480 μs to inject a mass of 3 mg.

Now, to inject this fuel mass of 3 mg, it suffices to derive the PW from the correspondence table of each injector, using the opening time A as input variable. Such correspondence tables are corrective tables that allow to derive the operating PW value, already integrating the injector specific OD and CR. Hence, additional correction of the PW for injector response delays in not required.

As it will be understood from FIG. 4, at A=480 μs, the PW varies between 220 and 280 μs, depending on the injector. For each injector, the respective PW corresponding to A=480 μs is thus obtained from the individual correspondence tables.

In FIG. 4 one can however notice that for very low fuel injections, i.e. relatively small A or PW values, say for A below 400, a diverging behaviour appears. This is due, in the present example, to the detection method for measuring the OD and CR that was chosen in the present example. Indeed, for very small injections, detecting the CR based on the voltage trace of the injector solenoid does not perform well, thus leading to substantial variability in this range.

To tackle this issue, the present method advantageously uses a virtual “pivot point” of given open time value A and PW, say (A0; PW0), that is determined by testing/calibration as the zero flow point, i.e. the point corresponding to the largest pulse width at zero flow.

The pivot point is thus advantageously used as lower end point in the correspondence function (table or curve) and will allow determination of low PW values by interpolation.

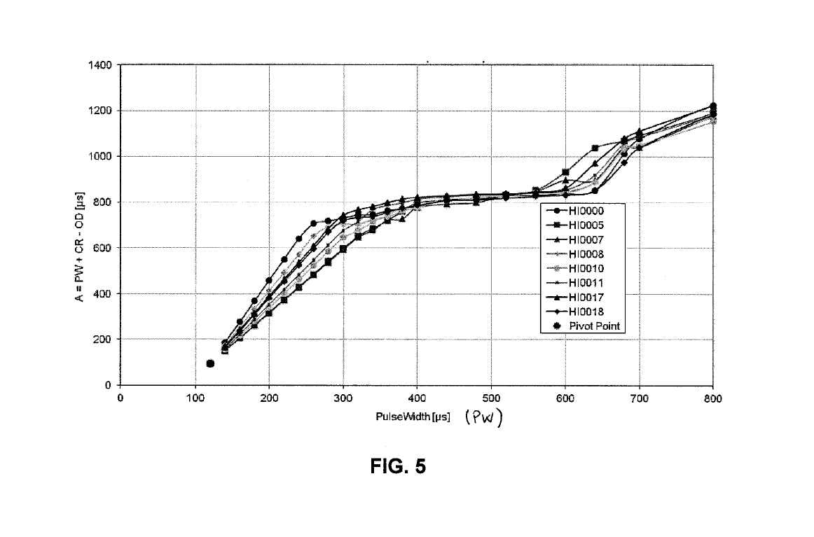

It shall be appreciated that it has been found that such pivot point may be dependent on the injector design, and in such condition the same pivot point can be applied to all the injector-specific correspondence tables. Such convergence can be grasped from FIG. 5.

It may be noticed that in the example of FIG. 5 the injectors have a relatively constant OD and the pivot point was determined by calibration. It is however worth noting that the point PW0, which is the abscissa of the pivot point may corresponds to the largest PW at zero flow or the smallest PW at which fuel is delivered by the injector (also known in the art as the Minimum Delivery Pulse—MDP). Various methods are known to determine such MDP, which then allows measuring the MDP in the running engine. Measuring the MDP in the engine allows updating the PW0 position of the pivot point to take into account ageing. In such case, one may use a mapping of PW0 vs. A0, so that when the abscissa of the pivot point changes due to a different MDP, the ordinate A0 may also be adapted. Also, the MDP value is close to the largest PW value at zero flow and may serve as a basis for determining the latter with more precision.

1. A method of controlling fuel injection in an internal combustion engine having at least one cylinder with an associated fuel injector for performing injection events, wherein for each injection event a drive signal is generated, with which the injector is kept open to spray fuel in accordance with a requested fuel quantity;
wherein said drive signal has a duration based on a pulse width that is determined from an injector-specific correspondence function defining said pulse width vs. a corresponding open time variable representative of injector open time;
said open time variable being determined on the basis of a master performance function defining the requested fuel quantity in function of the open time variable.

2. The method according to claim 1, wherein said injector-specific correspondence function takes the form of a table that is initially populated with calibrated values, or populated by learning after a first engine start-up.

3. The method according to claim 1, wherein said correspondence function is updated in a periodic or non-periodic manner.

4. The method according to claim 1, wherein pulse width values are derived from said injector-specific correspondence function either by direct reading or by mathematical analysis from discrete values stored in a corresponding table.

5. The method according to claim 1, wherein said master performance function is expressed as a table with discrete values or as a mathematical expression.

6. The method according to claim 1, wherein said open time variable corresponds to the time period during which the injector pintle is raised from its valve seat.

7. The method according to claim 1, wherein said open time variable is calculated as A=PW+a·CR−b·OD, where:
A is the open time variable,
PW is the pulse width,
CR is the measured Closing Response, and
OD is the opening delay.

8. The method according to claim 1, wherein the pulse width is determined by mathematical analysis using a pre-determined pivot point defined by a given open time variable and a given pulse width, which corresponds to the largest pulse width at zero flow.

9. The method according to claim 8, wherein said pre-determined pivot point is the same for all injector-specific correspondence functions.

10. The method according to claim 8, wherein the given pulse width of said pre-determined pivot point is periodically measured and adapted, if necessary.

11. The method according to claim 8, wherein the given open time variable of said pre-determined pivot point is read from a table based on its measured pulse width.

12. A fuel injection system comprising:
an injector driver stage connected to a plurality of injectors and adapted to generate for each injector a respective drive signal having a pulse width in order to perform an injection event; and
a control unit having associated therewith:
a master performance function defining a requested fuel quantity in function of an open time variable representative of injector open time; and
an injector-specific correspondence function defining, for each injector, a pulse width (PW) in function of said open time variable;
wherein said control unit is configured to determine the pulse width of the drive signal for a given injector by first determining, on the basis of said master performance function, the open time variable corresponding to the requested fuel quantity, and then deriving from the respective injector-specific correspondence function the pulse width corresponding to the previously determined open time variable.

13. The system according to claim 12, wherein pulse width values are derived from said injector-specific correspondence function either by direct reading or by mathematical analysis from discrete values stored in a corresponding table.

14. The system according to claim 12, wherein said master performance function is expressed as a table with discrete values or as a mathematical expression.

15. The system according to claim 12, wherein said open time variable corresponds to the time period during which the injector pintle is raised from its valve seat.
